(19) United States
(12) Patent Application Publication
(10) Pub. No.: US 2007/0271515 A1
(43) Pub. Date: Nov. 22, 2007

(54) Algorithm used to maintain the relative position of the online contact that has focus in the screen when new presence data requires an update of the online contacts screen

(75) Inventor: Kenneth J. Park, Kathlamet, OR (US)

Correspondence Address: WILSON DANIEL SWAYZE, JR., 3804 CLEARWATER CT., PLANO, TX, 75025, US

(73) Assignee: Sharp Laboratories of America, Inc.

(21) Appl. No.: 11/437,916

(22) Filed: May 19, 2006

(51) Int. Cl. G06F 9/00

(52) U.S. Cl. 715/733; 715/751; 715/753

(57) ABSTRACT

A method for maintaining focus on a selected online user includes the steps of obtaining a list of online users including the selected online user and an non-selected online user, forming a focus on the selected online user, changing the status of the non selected online user, and maintaining said focus on said selected online user after the status of the non-selected online user has changed.

### BACKGROUND OF THE INVENTION

U.S. Pat. No. 6,795,096 to Meaden discloses a method and system for conditionally refreshing a collection view. The collection view refers to a collection of objects presented in a user interface environment such as a graphical user interface. The collection view is refreshed only once all of the selected objects have been processed. In addition, the view is refreshed only if an action performed on any of the selected objects affects the view.

### SUMMARY

A method for maintaining focus on a selected online user includes the steps of obtaining a list of online users including the selected online user and an non-selected online user, forming a focus on the selected online user, changing the status of the non selected online user, and maintaining said focus on said selected online user after the status of the non-selected online user has changed.

### BRIEF DESCRIPTION OF THE DRAWINGS

The embodiments may be understood by reference to the following description taken in conjunction with the accompanying drawings, in which, like reference numerals identify like elements, and in which:

FIG. 1 illustrates a system of an embodiment;

FIG. 2 illustrates a block diagram showing details of the system;

FIGS. 3a-q illustrates the operation of the embodiments;

FIG. 4 illustrates a first flowchart of the embodiments;

FIG. 5 illustrates a second flowchart of the embodiment;

FIG. 6 illustrates a third flowchart of the embodiments;

FIG. 7 illustrates a fourth flowchart of the embodiments.

### DETAILED DESCRIPTION

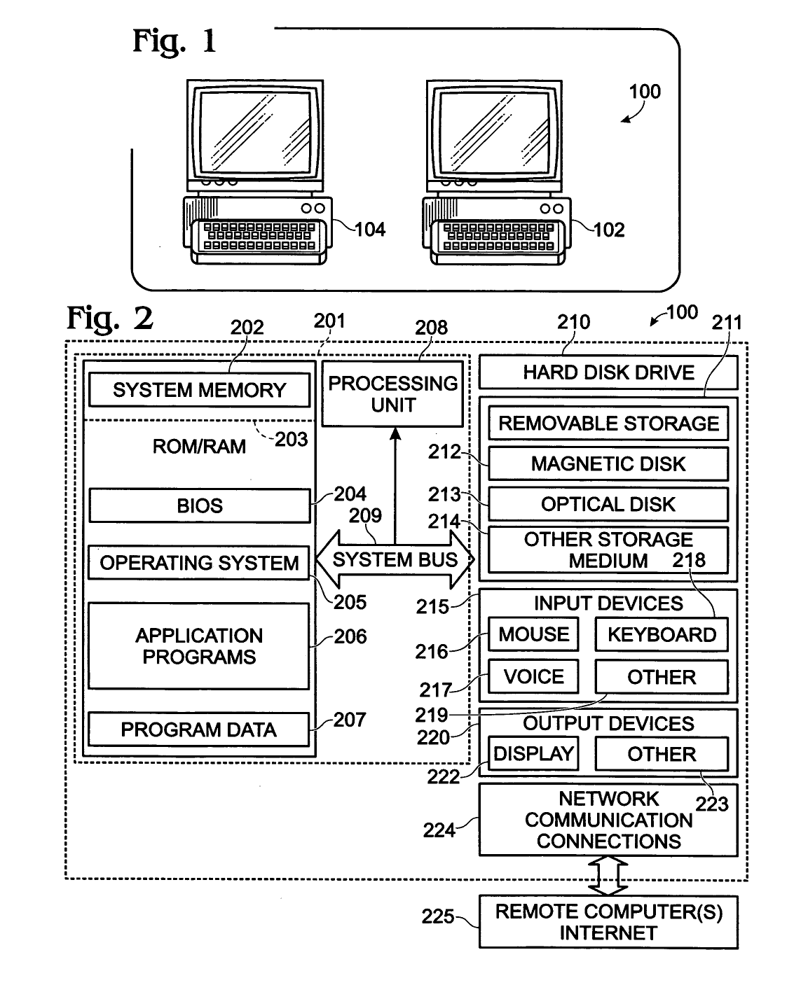

FIG. 1 illustrates a system 100 which allows users to access online services, which includes a first computer 102 and a second computer 104 and which may be used to execute the software of an embodiment, and FIG. 2 shows a block diagram of the one of the computers 102, 104 of the system 100 shown in FIG. 1. Although FIG. 1 illustrates the first computer 102 and the second computer 104, additional computers are within the scope of the embodiment. The system 100 includes output devices 220, such as, but not limited to, a display 222, and other output devices 223; input devices 215 such as, but not limited to, a mouse 216, a voice input device 217, a keyboard 218 and other input devices 219; removable storage 211 that may be used to store and retrieve software programs incorporating code that aids or executes the embodiment or stores data for use with the embodiment, or otherwise interacts with the embodiment, such as, but not limited to, magnetic disk storage 212, optical storage 213 and other storage 214, a hard drive 210 that may be used to store and retrieve software programs incorporating code that aids or executes the embodiment or stores data for use with the embodiment, or otherwise interacts with the embodiment; and system components, such as those within dashed line 201, including but not limited to system memory 202, which includes BIOS (Basic Input Output System) 204, RAM (Random Access Memory) and ROM (Read Only Memory) 203, an operating system 205, application programs 206, program data 207, a processing unit 208, system bus 209, and network and or communications connections 224 to remote computers, an intranet which access is available to members of the organization and/or the Internet 225. Examples of such systems 100 includes without limitation personal computers, digital assistants, smart cellular telephones and pagers, dumb terminals interfaced to an application server and the like. The network includes various topologies, configurations, and arrangements of network interconnectivity components arranged to interoperability couple with enterprise, wide area and local area networks and include wired, wireless, satellite, optical and equivalent network technologies. The Internet has various online services providers for which a user may wish to obtain the service. These service providers provide various services, and among the service that they provide is a list of the users that are currently or actively using the service. This information is generally provided by a set of functions that provide specific information with respect to the online users. One such service provider is providing the service of online messaging or instant messaging between two or more users where the online users can contact each other almost simultaneously.

In general, there is a list of items to be displayed. The list is dynamic with items being added and removed from the list at any time. The user selects an item from the list so that the user can interact with the item in some way. As the status of the items change for example being added or removed from the list, the user desires to preserve the continuity of the displayed items. A focus is displayed on a screen of an output device which allows the user to point at a component that is a visual image such as text, a picture, a button, a list box or a check box. Furthermore, a component could be a menu option. The focus displayed on the screen allows the user to point at the component on the output device 220 such as the display 222 by using the input device 214 such as a keyboard or mouse. The focus is a visual indication showing an area on the screen to which the user is currently referring and may be represented by a dotted box or a highlighted area enclosing the component. When the user has the focus indicating the component which the user is referring to, the component is said to be focused on or in focus.

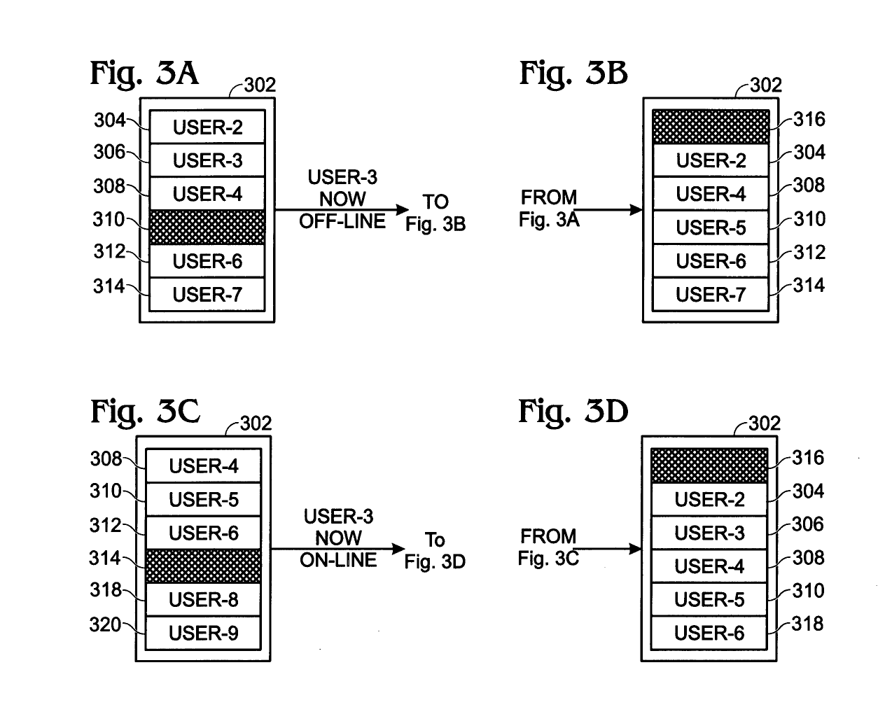

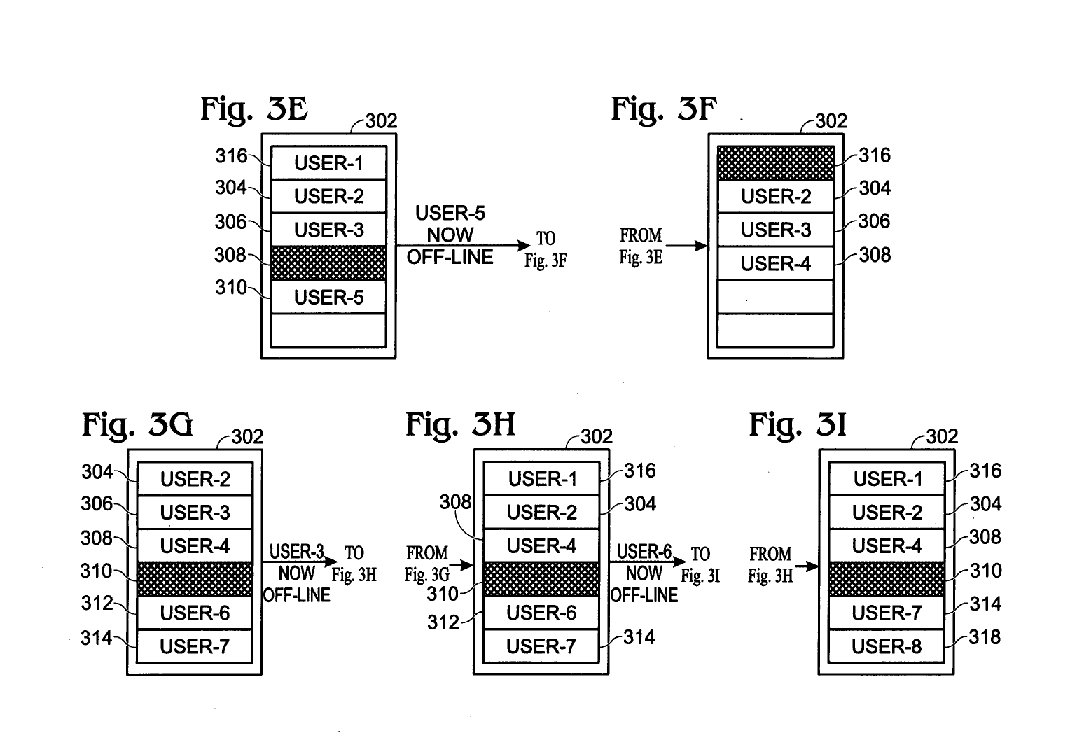

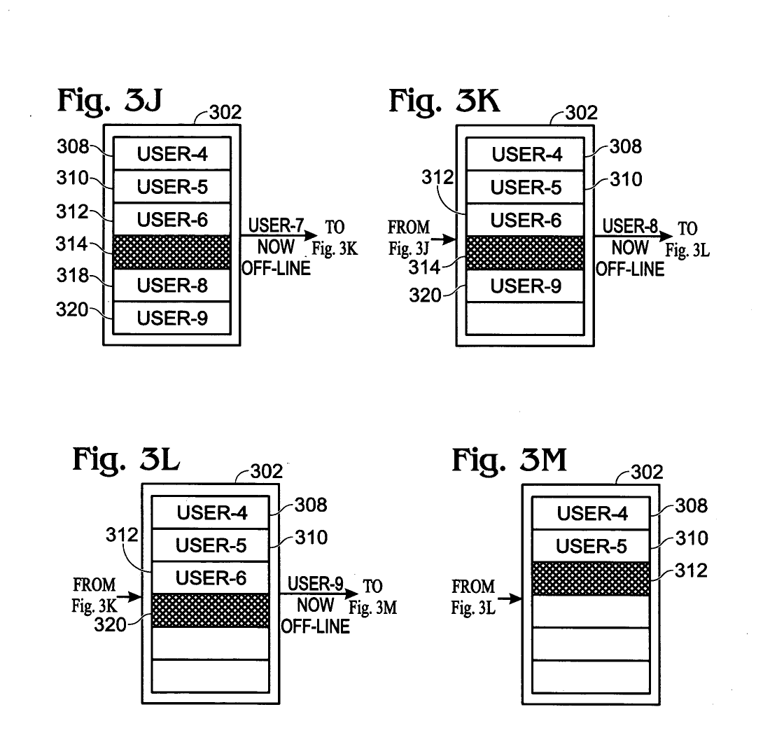

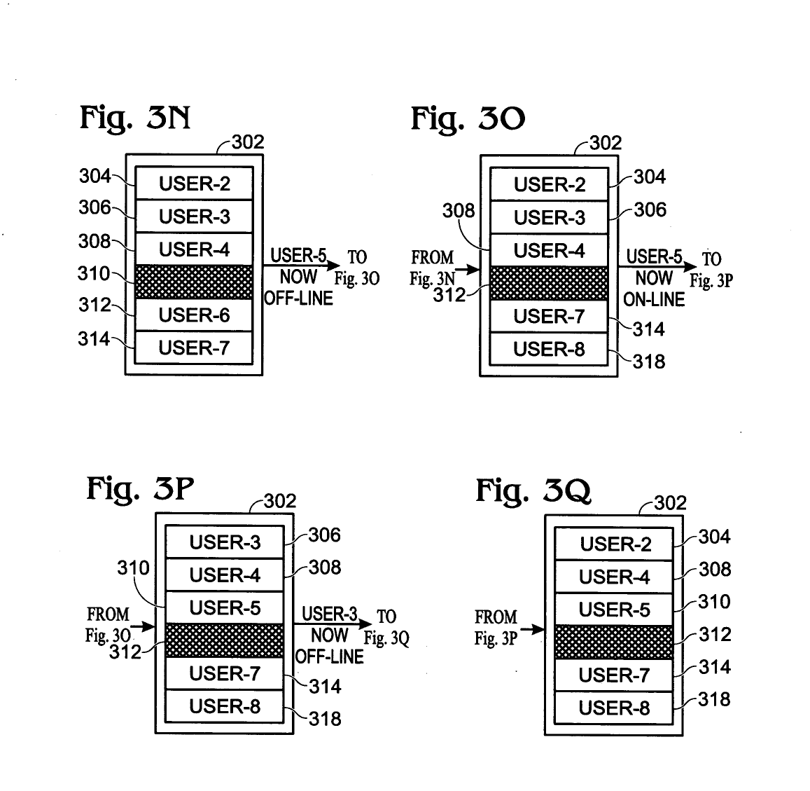

FIG. 3a illustrates a screen 302 displaying online users from a list. Additionally for sake of explanation, the users online on the list are the first user 316 through the ninth user 320. The number of online users is almost without limit, but the embodiment will use for sake of explanation nine users. More particularly, the screen 302 displays only a portion of the users that are currently online and is currently displaying the second user 304, the third user 306, the fourth user 308, the fifth user 310, the sixth user 312 and the seventh user 314. The remaining users, namely the first user 316, the eighth user 318 and the ninth user 320 are in the list but not shown on the screen 302. All of the users could be displayed on screen 302. Furthermore, the user of the screen 302 has scrolled to the fifth user 310, placing the fifth user 310 in focus. After a period of time, the third user 306 goes off-line as shown in FIG. 3b, resulting in the screen 302 showing the first user 316, the second user 304, the fourth user 308, the fifth user 310, the sixth user 312 and the seventh user 314 online. The first user 316 has been added to the screen 302. However, the screen 302 in FIG. 3b shows that the focus has moved from the fifth user 310 to the first user 316, leaving the fifth user 310 without focus.

FIG. 3c shows an example of adding an online user and the effect that this change has on the focus. In FIG. 3c, the first user 316, the second user 304 and the ninth user 320 are online but is not shown on the screen 302; the third user 306 is off-line and is not being shown on the screen 302. The screen 302 does show that the fourth user 308, the fifth user 310, the sixth user 312, the seventh user 314, the eighth user 318 and the ninth user 320 are online and the user of the screen 302 has scrolled down to place the seventh user 314 in focus.

After a period of time, the third user 306 goes on-line, and FIG. 3d shows the first user 316, second user 304, third user 306, fourth user 308, the fifth user 310 and the sixth user 312 as being online users to the user of the screen 302. Now, the first user 316 is in focus and the seventh user 314 is not shown on the screen 302 but still is an online user. The user of the screen 302 has lost focus.

In FIG. 3e, the online users being displayed on the screen 302 are the first user 316 through the fifth user 310. FIG. 3e illustrates that the first user 316, the second user 304, the third user 306, the fourth user 308 and the fifth user 310 are displayed on the screen 302 as being online users. The user of the screen 302 has scrolled down to the fourth user 308 and placed the fourth user 308 in focus.

The fifth user 310 goes off-line, and results are shown in FIG. 3f. The first user 316, the second user 304, the third user 306 and the fourth user 308 are shown on the screen 302 as being online. The focus is lost from the fourth user 308 and has moved to the first user 316.

In all the above instances, the user of the screen 302 loses the focus on the desired user that had been selected by the user of the screen 302 because the focus on the screen 302 is reset to the user at the top on the screen 302. This would cause the user of the screen 302 the need to scroll down the display and re-focus on the desired user whenever there is a change in the status of any of the users displayed on the screen 302. The change in status could be a displayed user going into an off-line state or an off-line user going into the online state.

FIGS. 3g-i illustrate an aspect of the embodiment showing the online users including the first user 316 through the ninth user 320 but not all of the online users on the list are displayed. FIG. 3g illustrates that the second user 304, the third user 306, the fourth user 308, the fifth user 310, the sixth user 312 and the seventh user 314 are online and displayed by the screen 302 which could be one of the output devices for any of the above devices; and the user of the screen 302 has scrolled down to the fifth user 310, placing the fifth user 310 in focus. The fifth user 310 is a selected user by the user of the screen 302 because the fifth user 310 is in focus while the second user 304, the third user 306, the fourth user 308, the sixth user 312 and the seventh user 314 are unselected users because these users are not in focus.

FIG. 3h shows the effect of the third user 306 going off-line. FIG. 3h shows the first user 316, the second user 304, the fourth user 308, the fifth user 310, the sixth user 312 and the seventh user 314 online. The focus remains on the fifth user 310 without the user of the screen 302 refocusing the screen 302. The change in status of the third user 306 by going off-line does not affect the focus on the screen. Note, the displayed online users collapse from the top, adding the first user 316 to the display. The relative position of the focus with respect to the top of the screen 302 does not change.

FIG. 3i shows the effect of the sixth user 312 going off-line. FIG. 3i shows the first user 316, the second user 304, the fourth user 308, the fifth user 310, the seventh user 314 and the eighth user 318 online and displayed on the screen 302. The focus remains on the fifth user 310 without the user of the screen 302 refocusing the screen 302. The change in status of the sixth user 312 going off-line does not affect the focus of the screen 302. The displayed online users could collapse from the bottom, adding the eighth user 318. The relative position of the focus with respect to the top of the screen 302 does not change.

FIGS. 3j-m illustrate another aspect of the embodiment. As an initial condition in FIG. 3j, the first user 316 through the ninth user 320 are online and in the list, and the user of the screen 320 has scrolled down to the seventh user 314 and places the seventh user 314 in focus. The seventh user 314 is the selected user by the user of the screen 302 while the fourth user 308, the fifth user 310, the sixth user 312, the eighth user 318 and the ninth user 320 are unselected users. The screen 302 displays the fourth user 308, the fifth user 310, the sixth user 312, the seventh user 314, the eighth user 318 and the ninth user 320 online.

After a period of time, the seventh user 314 goes off-line. The screen 302 in FIG. 3k displays the fourth user 308, the fifth user 310, the sixth user 312, the eighth user 318 and the ninth user 320 as online users. The eighth user 318 is now in focus. The focus does not shift to the top of the screen 302. The screen 302 does not shift down to fill the empty rows in attempt to keep the display fully populated. The relative position of the focus with respect to the top of the screen 302 does not change.

After a period of time, the eighth user 318 goes off-line, and results are shown in FIG. 3l. The screen 302 displays that the fourth user 308, the fifth user 310, the sixth user 312 and the ninth user 320 are online with the ninth user 320 being in focus without needing the user of the screen 302 to scroll down and refocus. The display of the screen 302 does not shift down to fill empty rows in an attempt to keep the display fully populated. The relative position of the focus with respect to the top of the screen 302 does not change.

After a period of time, the ninth user 320 goes off-line, and the results are shown in FIG. 3m. FIG. 3m shows the screen 302 displaying the fourth user 308, the fifth user 310 and the sixth user 312 as being online. The sixth user 312 is in focus, and the focus is not significantly affected by the change in status of the ninth user 320 going off-line. Consequently, the user of the screen 302 is not required to scroll down and refocus. The display of the screen 302 does not shift down to fill empty rows in an attempt to keep the display fully populated.

In FIGS. 3n-q, the first user 316 through the ninth user 320 are initially online, and the user has the initially scroll down to place in focus the fifth user 310. The fifth user 310 is a selected user by the user of the screen 302 while the second user 304, the third user 306, the fourth user 308, the sixth user 312 and the seventh user 314 are the unselected users. FIG. 3n shows that the second user 304, the third user 306, the fourth user 308, the fifth user 310, the sixth user 312 and the seventh user 314 are displayed on the screen 302. The relative position of the focus with respect to the top of the screen 302 does not change.

After a period of time, the fifth user 310 is off-line. FIG. 3o shows that the screen 302 displays the second user 304, the third user 306, the fourth user 308, the sixth user 312, the seventh user 314 and the eighth user 318 with the sixth user 312 in focus. The relative position of the focus with respect to the top of the screen 302 does not change. The focus does not return to the top of the screen 302. The screen 302 adds the eighth user 318 to keep the screen 302 filled, eliminating the empty row.

After a period of time, the fifth user 310 is on-line. FIG. 3p illustrates that the screen 302 displays the third user 306, the fourth user 308, the fifth user 310, the sixth user 312, the seventh user 314 and the eighth user 318 as being online with the sixth user 312 being in focus. The relative position of the focus with respect to the top of the screen 302 does not change. The topmost user, namely the second user 304, is eliminated from the display of the screen 302 in order to accommodate the fifth user 312.

After a period of time, the third user 306 is off-line. The screen 302 in FIG. 3q displays the second user 304, the fourth user 308, the fifth user 310, the sixth user 312, the seventh user 314 and the eighth user 318 with the sixth user 312 being in focus. The sixth user 312 remains in focus despite the change in status of the third user 306 by going off-line and without the user of the screen 302 refocusing.

Next, a description of the further operation of the embodiments will be presented. While specific functions and variable names are used in the operation, the embodiments should not be limited to the specific functions and variables.

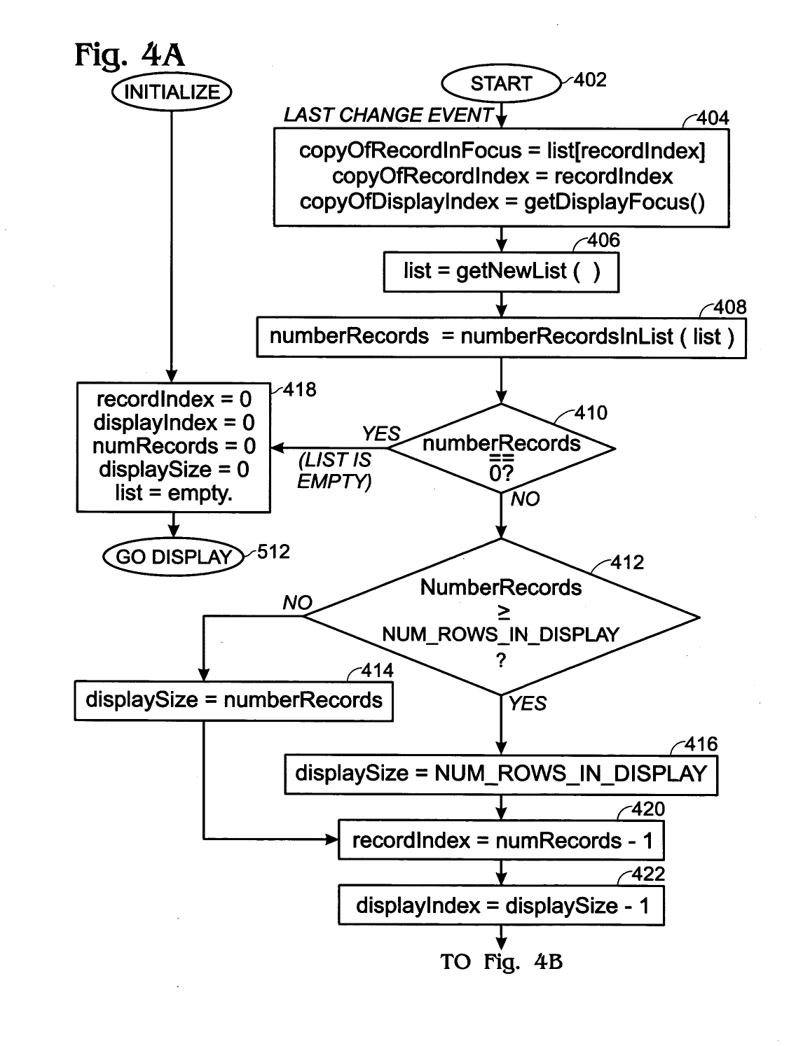

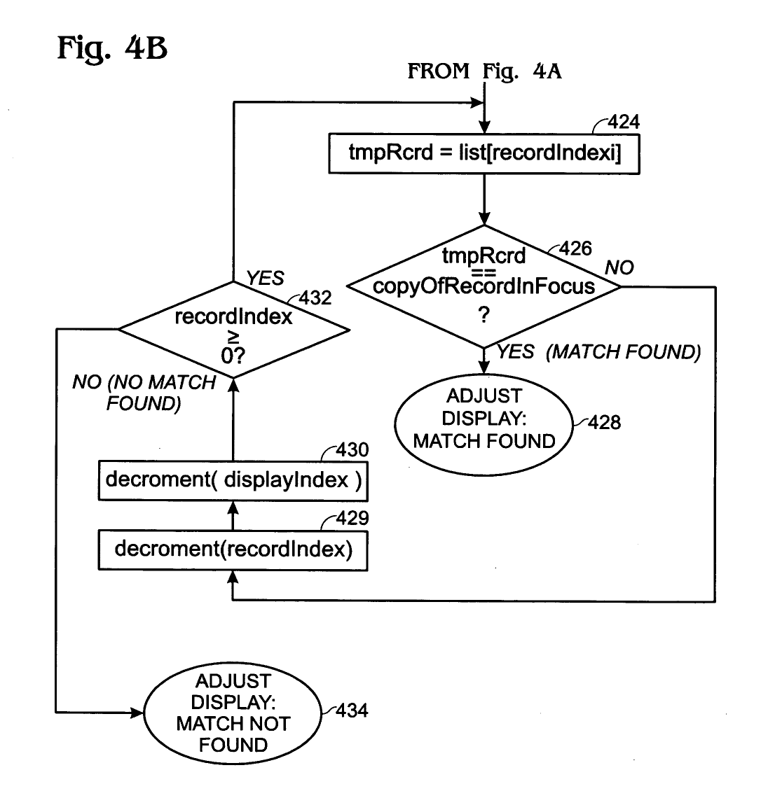

FIG. 4 illustrates a flow chart of the embodiment, and the flowchart starts at step 402. The list which is shown with the parameter of the recordIndex includes the ‘online contacts’ for instant messaging which may represent the people that are online and may be in some sorted order for example alphabetical, by age etc. The list can also be considered as a list of record objects. The recordIndex is an index to a record in the list of online contacts that has focus on the display, and the value of this variable may range from zero to numberRecords minus one.

Next, in step 404 after a list change event, a copyOfRecordInFocus variable is obtained from the list function based upon the parameter of the recordIndex variable.

A copyOfRecordIndex variable is obtained from the recordIndex variable, and a copyOfDisplayIndex variable is obtained from the getDisplayFocus function. The getDisplayFocus function returns an index that is associated with the line that has focus in the display on the screen 302. The values of the getDisplayFocus function can vary from zero to displaySize minus one. Next, in step 406, a list variable is obtained from the getNewList function which returns a list which can be considered an array of indexes in which each index points to a record. Next in step 408, the numberRecords variable is obtained by the numberRecordsInList(parameter) function which returns the number of records in a list. The parameter for the numberRecordsInList is the list object, for example an array of indexes. Here, the numberRecordsInList function returns the number of records in the list which is passed to it as a parameter which is the list variable obtained in step 406.

In step 410, is determined if the list is empty by determining if the numberRecords variable equals zero. If the numberRecords variable is equal to zero, the list is empty and then control passes to step 418; and if the numberRecords variable is not equal to zero then the numberRecords variable is compared to the NUM_ROWS_IN_DISPLAY variable which is the number of lines that potentially can be displayed on screen 302 in step 412. If the numberRecords variable is not greater than and not equal to the NUM_ROWS_IN_DISPLAY variable, then in step 414, the displaySize variable is set to the numberRecords variable. However, if the numberRecords variable is greater than or equal to the NUM_ROWS_IN_DISPLAY variable, then in step 416, the displaySize variable is set to the NUM_ROWS_IN_DISPLAY variable. The displaySize variable is the number of lines that can be filled with data from the list and can be between 1 to MIN(numRecords, NUM_ROWS_IN_DISPLAY) where the MIN function returns the smaller of the two parameters. From either step 414 or 416, step 420 is executed next. In step 420, the recordIndex variable is set to be the numRecords variable minus one. The numRecords variable is the number of online contacts records in the list. Next in step 422, the displayIndex variable is set to be the displaySize variable minus one and may or may not be an index to the line on the display that has focus. Next in step 424, the tmpRcrd variable is set from the list function based upon the recordIndex variable as the parameter. In step 426, the tmpRcrd variable is compared with the copyOfRecordInFocus variable. If the tmpRcrd variable is equal to the copyOfRecordInFocus, than the Adjust Display; Match Found step is executed in step 428. The displayIndex variable points to the line that has focus. If the tmpRcrd variable is not equal to the copyORecordInFocus variable, then step 429 is executed which decrements the recordIndex variable by the decrement (parameter) function which subtracts one from the parameter of the recordIndex variable. In step 430, the displayIndex variable is decremented by one by the decrement function, and in step 432 the recordIndex variable is compared to zero. If the recordIndex is not greater than and not equal to zero, then in step 434, the Adjust Display; Match Not Found is executed, and the displayIndex does not now point to the line that has focus. If the recordIndex variable is greater than or equal to zero then control passes to step 424.

If initialization is required, then step 418 is executed. In step 418, the recordIndex variable is set to zero, the displayIndex variable is set to zero, the numRecords variable which is the number of online contact records in the list and which is set to zero, the displaySize variable which is the number of lines on the display that will be filled with data from the list and which may have values ranging from one to MIN(numRecords, NUM_ROWS_IN_DISPLAY) is set to zero, and a list is set to empty.

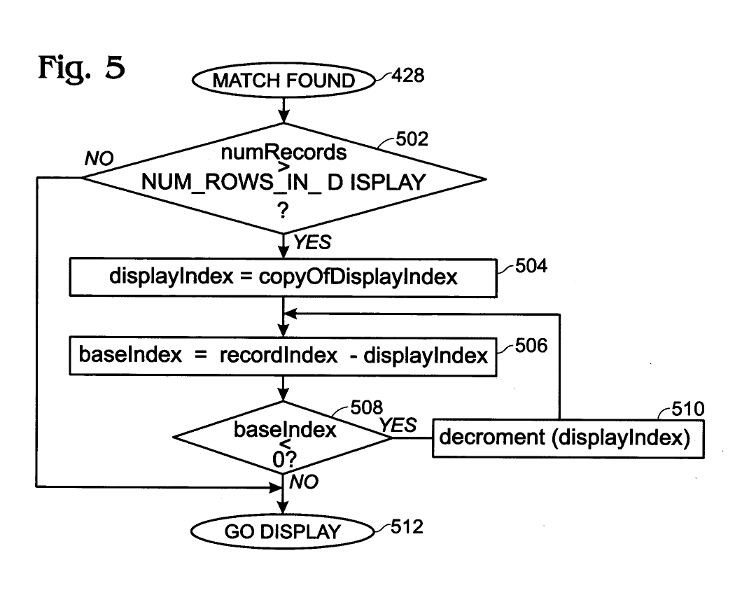

FIG. 5 illustrates the steps when the match found in step 428. In step 502, the numRecords variable is compared with the NUM_ROWS_IN DISPLAY variable. If the numRecords variable is greater than the NUM_ROWS_IN_DISPLAY variable, then in step 504, the displayIndex variable is set to the copyOfDisplayIndex variable. Control then passes to step 506 where the baseIndex variable which is an index to the record in the list of online contacts that is at the first line on display is set to the recordIndex variable minus the displayIndex variable. Control the passes to step 508. If the numRecords variable is not greater than the NUM_ROWS_IN_DISPLAY variable in step 502 then control passes to step 512 to display the results in Go Display. In step 508, if the baseIndex variable is less than zero then control passes to step 510 where the displayIndex variable is decremented by one by the decrement function. Control then passes to step 506. In step 508, if the base index is not less than zero then the results in the Go Display are displayed in step 512 and the displayIndex variable now points to the line in the display that has focus.

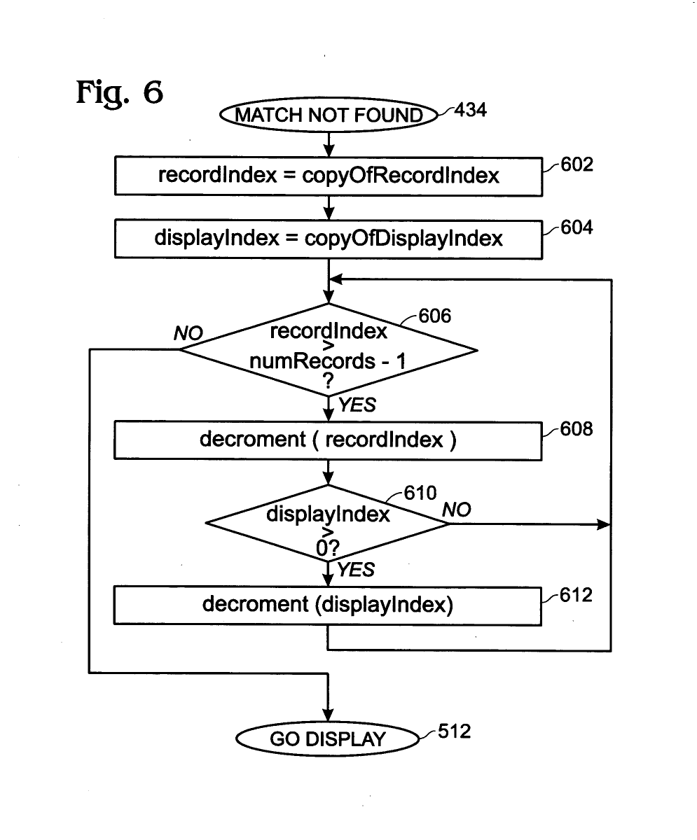

FIG. 6 illustrates the series of steps that are executed when the Match Not Found. Control passes to step 434 when it is determined that a match has not been found such as shown in FIG. 4. In step 602, the recordIndex variable is set to the copyOfRecordIndex variable, and in step 604, the displayIndex variable is set to the copyOfDisplayIndex variable. In step 606, the recordIndex variable is compared with the numRecords variable minus one. If the recordIndex variable is not greater than the numRecords variable minus one then control passes to step 614. If the recordIndex variable is greater than the numRecords variable minus one then the recordIndex variable is decremented by the decrement function in step 608. In step 610, the displayIndex variable is compared with zero. If the displayIndex variable is greater than zero then control passes to step 612, but if the displayIndex variable is not greater than zero then control passes to step 606. In step 612, the displayIndex variable is decremented by the decrement function and control passes to step 606.

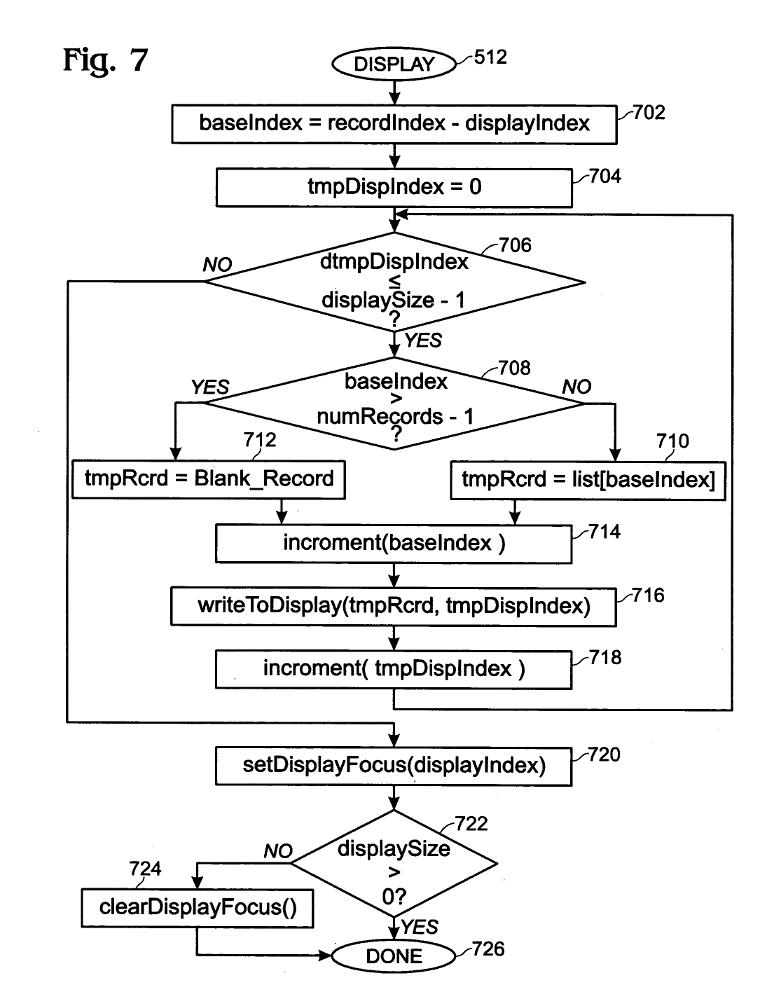

FIG. 7 shows the series of steps to display the online users without moving the focus on the screen 302 when the users move between the online state and the off-line state. The flowchart starts at step 700, and in step 702, the baseIndex variable is set to the recordIndex variable minus the displayIndex variable. The baseIndex variable is an index to the record in the list of online contacts that is at the first line on the display. The displayIndex variable is an index to the line of the display that currently has focus, and the recordIndex variable is an index to the record in the list for example the online contacts that has focus on the display. The tmpDispIndex variable is set to zero in step 704. In step 706, the tmpDispIndex variable is compared with the displaySize variable which is the number of lines on the display that will be filled with data from the list minus one. If the tmpDispIndex variable is less than or equal to the displaySize variable minus one, then step 708 is executed. If the tmpDispIndex variable is greater than the displaySize variable minus one then step 720 is executed. In step 708, the baseIndex variable which is an index to a record in the list, for example the list of online contacts, and which is at the first line on the display, is compared with the numRecords variable minus one. If the baseIndex variable is greater than the numRecords variable minus one, step 712 is executed. If the baseIndex variable is not greater than the numRecords variable minus 1, then step 710 is executed to set the tmpRcrd variable equal to the list function based on the parameter, baseIndex. In step 712, the tmpRcrd variable is set equal to the Blank_Record variable which contains no data and is used to display an empty line.

In step 710, the tmpRcrd is set to the list based on the parameter, baseIndex variable. After either step 710 or step 714, the baseIndex variable is incremented by one using the increment (parameter) function which increments the parameter by one in step 714. In step 716, the writeToDisplay function is executed based upon the parameters, the tmpRcrd variable and the tmpDispIndex variable. The writeToDisplay function writes to the display of the screen of 302 the contents contained in the first parameter of the writeToDisplay function at the location in the display defined by the second parameter of the writeToDisplay function.

Consequently, the tmpRcrd variable is written to the display at the location defined by the tmpDispIndex variable. In step 718, the tmpDispIndex variable is incremented by the increment function and control returns to step 706.

In step 720, the setDisplayFocus function with the parameter of displayIndex is executed which sets the line that has the focus in the display from the value passed to the function as a parameter. This function will turn the focus on if it is currently off.

In step 722, the displaySize variable is compared to zero. If the displaySize variable is not greater than zero then, in step 724, the clearDisplayFocus function is executed. This clearDisplayFocus function turns the focus off. Control passes to step 726. If the displaySize variable is greater than zero, control passes to step 726. In steps 726, the routine ends.

Another embodiment could include a display showing a list of radio stations which the users can clearly receive because there is sufficient signal strength to decode the music clearly. The user can select a station from the list so that the radio of the user may be tuned to the station. As the user moves, the status of the list of radio stations will change, some radio stations will be added when there is sufficient signal strength while other radio stations may be removed when the signal strength becomes too low. However, the user will desire to remain with the selected station.

Another embodiment could include a display showing a list of freeways available for example for your local commute, and the list shows whether or not that the traffic is operating near or at the posted speed limit. The traffic conditions will change, and status of the list of the freeways will change as the traffic speeds up or slows down on the freeways. The user may select a particular freeway and may desire to maintain this selection despite the changing status based on traffic conditions.

In an alternate embodiment, the display may show a list of retailers that have an item for sale for a price less than some predetermined amount. If one of the retailers increases the price above the predetermined amount, the status of this retailer is changed, and this retailer is removed from the list. Another retailer may drop the price of the item below the predetermined amount. This will result in the retailer being added to the list. The user would select one of the retailers in order to obtain further information about the retailer and the item for sale. The user would like to maintain this selected retailer despite the changes in the status of the list.

While the embodiments are susceptible to various modifications and alternative forms, specific embodiments thereof have been shown by way of example in the drawings and are herein described in detail. It should be understood, however, that the description herein of specific embodiments is not intended to limit the embodiment to the particular forms disclosed.

1. A method for maintaining focus on a selected online user, comprising the steps of:
obtaining a list of online users including said selected online user and an non-selected online user;
forming a focus on said selected online user;
changing the status of said non selected online user;
maintaining said focus on said selected online user after said status of said non-selected online user has changed.

2. A method for maintaining focus on a selected online user as in claim 1, wherein said online users are online for instant messaging.

3. A method for maintaining focus on a selected online user as in claim 1, wherein said step of changing the status includes moving said non-selected user from an off-line user to an online user.

4. A method for maintaining focus on a selected online user as in claim 1, wherein said step of changing the status includes moving from an online user to an off-line user.

5. A method for maintaining focus on a selected online user as in claim 1, wherein said selected and non-selected online users are displayed on a screen.

6. A method for maintaining focus on a selected online user as in claim 5, wherein only a portion of said non-selected online users are displayed on said screen.

7. A method for maintaining focus on a selected online user as in claim 1, wherein said selected and non-selected online users collapse from the top after the change in status of said non-selected user.

8. A method for maintaining focus on a selected online user as in claim 1, wherein said display of said selected and non-selected online users collapse from the bottom after the change in status of said non-selected online user.

9. A method for maintaining focus on a selected online user as in claim 1, wherein said focus changes to said selected online user and maintains the relative position of said focus.

10. A method for maintaining focus on a selected online user as in claim 5, wherein said screen is not fully populated with said selected and non-selected on line users after said change in said status of said non-selected online user.

11. A system for maintaining focus on a selected online user, comprising:
an output device for displaying a list of online users including said selected online user and an non-selected online user;
a computer coupled to said output device for forming a focus on said selected online user;
said computer changing the status of said non selected online user;
said computer maintaining said focus on said selected online user after said status of said non-selected online user has changed.

12. A system for maintaining focus on a selected online user as in claim 11, wherein said online users are online for instant messaging.

13. A system for maintaining focus on a selected online user as in claim 11, wherein said computer moves said non-selected user from an off-line user to an online user.

14. A system for maintaining focus on a selected online user as in claim 11, wherein said computer moves from an online user to an off-line user.

15. A system for maintaining focus on a selected online user as in claim 11, wherein said output device includes a screen for displaying said selected and non-selected online users.

16. A system for maintaining focus on a selected online user as in claim 15, wherein said screen displays only a portion of said non-selected online users.

17. A system for maintaining focus on a selected online user as in claim 11, wherein said computer collapses said selected and non-selected online users from the top after the change in status of said non-selected user.

18. A system for maintaining focus on a selected online user as in claim 11, wherein said computer collapses the display of said selected and non-selected online users from the bottom after the change in status of said non-selected online user.

19. A method for maintaining focus on a selected online user as in claim 11, wherein said computer changes said focus on said selected online user and maintains the relative position of said focus on said output device.

20. A method for maintaining focus on a selected online user as in claim 15, wherein said screen is not fully populated with said selected and non-selected on line users after said change in said status of said non-selected online user.
